(19) United States
(12) Patent Application Publication
(10) Pub. No.: US 2025/0367623 A1
(43) Pub. Date: Dec. 4, 2025

(54) THERMAL PROCESS SYSTEMS

(71) Applicant: Honeywell International Inc., Charlotte, NC (US)

(72) Inventors: Abigail Parsons, South Bend, IN (US); Amanda Childers, Arlington Heights, IL (US)

(21) Appl. No.: 18/794,760

(22) Filed: Aug. 5, 2024

Related U.S. Application Data
(60) Provisional application No. 63/654,625, filed on May 31, 2024.

(51) Int. Cl. B01J 6/00; C01B 3/30; F27B 5/14; F27B 5/16; F27B 5/18

(52) U.S. Cl. CPC B01J 6/008; C01B 3/30; F27B 5/14; F27B 5/16; F27B 5/18; C01B 2203/0272; C01B 2203/0805; C01B 2203/1241; F27B 2005/164

(57) ABSTRACT

A thermal process system includes a retort assembly and a heating assembly. The retort assembly includes a retort chamber defining a longitudinal axis, and is configured to substantially contain one or more gases in the retort chamber during a thermal process house substrate material within the retort chamber. The heating assembly includes a plurality of heating elements adjacent to the retort chamber that is configured to selectively generate two or more heating zones at different axial positions along the longitudinal axis within a heating region.

This application claims the benefit of U.S. Provisional application No. 63/654,625, entitled “THERMAL PROCESS SYSTEMS” and filed on May 31, 2024, which is incorporated herein by reference in its entirety.

### TECHNICAL FIELD

The present disclosure relates to substrate loading in thermal process systems.

### BACKGROUND

Thermal processes, such as vapor-phase reactions, may involve chemical vapor deposition (CVD) of a solid product onto a substrate. For example, in methane pyrolysis, methane breaks down at high temperatures to form solid carbon that deposits onto surfaces of the substrate. The amount of solid carbon that may be loaded onto the substrate may be limited by the surface area of the substrate that is exposed to the methane.

### SUMMARY

In general, the disclosure describes thermal process systems, such as reactor systems, configured to selectively heat portions of a retort assembly to improve loading of a substrate material in the retort assembly and reduce power consumption of the thermal process system.

A thermal process system is configured to maintain a thermal process, such as a reaction, in which one or more process gases generate product solids through chemical vapor deposition (CVD), alone or in addition to one or more product gases. The thermal process system includes a retort assembly for containing the process gases and housing a substrate material. The retort assembly includes a retort chamber and one or more retort lids that seal the retort assembly, and has an elongated form that defines flow of the process gases from one end of the retort assembly to the other.

The thermal process system also includes a heating assembly that includes heating elements adjacent to and positioned around the retort chamber for heating the contents of the retort chamber. Rather than heat the entire contents of the retort chamber at once, the heating elements selectively generate heating zones at different axial positions along the retort chamber, such that only a portion of the retort chamber may be heated at a time. The thermal process is substantially limited to portions of the retort assembly that are near an active heating zone, including a portion of the substrate material, such that deposition of the solid product is limited to the portion of the substrate material in the heating zone. Once the portion of the substrate material is loaded with the product solid, another heating zone may be activated to load another portion of the substrate material; this selective heating of portions of the retort chamber may continue until the substrate material has been fully loaded. Such sequential heating of the retort chamber may more precisely control loading of the substrate material and reduce overall heating of the substrate material. In this way, thermal process systems described herein may have increased substrate utilization and reduced power consumption compared to thermal process systems that do not selectively control heating of the retort assembly.

In some examples, the disclosure describes a thermal process system that includes a retort assembly and a heating assembly. The retort assembly includes a retort chamber defining a longitudinal axis, and is configured to substantially contain one or more gases in the retort chamber during a thermal process and house substrate material within the retort chamber. The heating assembly includes a plurality of heating elements adjacent to the retort chamber. The plurality of heating elements is configured to selectively generate two or more heating zones at different axial positions along the longitudinal axis within a heating region.

In some examples, the disclosure describes a method that includes containing, by a retort assembly of a thermal process system, one or more gases in a retort chamber of the retort assembly during a thermal process. The retort assembly includes a retort chamber defining a longitudinal axis, and houses substrate material within the retort chamber. The method further includes maintaining, by a heating assembly of the thermal process system, the one or more gases at thermal process conditions by selectively generating, by a plurality of heating elements of the heating assembly, two or more heating zones at different axial positions along the longitudinal axis within a heating region. The plurality of heating elements is adjacent to the retort chamber.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a schematic block diagram illustrating an example thermal process system for generating an outlet gas mixture and capturing reaction product on a particle-based substrate material.

FIG. 1B is a flowchart of an example technique for reacting gases in a thermal process system.

FIG. 2A is a cross-sectional side view diagram illustrating an example thermal process system for generating an outlet gas mixture and capturing reaction product on a particle-based substrate material having a single opening.

FIG. 2B is a cross-sectional side view diagram illustrating an example thermal process system for generating an outlet gas mixture and capturing reaction product on a particle-based substrate material having a single opening.

FIG. 2C is a cross-sectional side view diagram illustrating generation of a heating region by the example thermal process system of FIG. 2B.

FIG. 3A is a cross-sectional side view diagram illustrating generation of a first heating zone at a first axial position by an example thermal process system.

FIG. 3B is a cross-sectional side view diagram illustrating generation of a second heating zone at a second axial position by an example thermal process system.

FIG. 3C is a cross-sectional side view diagram illustrating generation of a third heating zone at a third axial position by an example thermal process system.

FIG. 3D is a graph illustrating loading of the thermal process system over time for the first, second, and third heating zones of FIGS. 2A-2C.

FIG. 4A is a schematic block diagram illustrating an example pyrolysis reactor for generating hydrogen gas and capturing carbon on a lunar regolith substrate material.

FIG. 4B is a flowchart of an example technique for pyrolyzing hydrocarbons in a pyrolysis reactor.

### DETAILED DESCRIPTION

In general, the disclosure describes thermal process systems, such as reactor systems, configured to selectively heat portions of a retort assembly to improve loading of substrate material in the retort assembly and reduce power consumption of the thermal process system.

Thermal processes, such as chemical reactions, may generate product solids from process gases and deposit these product solids on surfaces within a retort. To collect these product solids and reduce fouling of the retort, substrate materials having a high surface area are placed in the retort. As the thermal process proceeds, the product solids deposit on the substrate material and fill spaces within the substrate, resulting in decreasing void fraction. However, the deposition rate of the product solids may be dependent on a temperature and composition of the process gases, which may vary based on proximity to heating elements and position in a flow of the process gases. As a result of a variable deposition rate, the substrate material may not evenly load prior to closing voids in the substrate material, resulting in portions of the substrate material that are inaccessible for further loading. Additionally, the retort may continue to heat portions of the substrate material that are already fully loaded, wasting energy.

According to the disclosure, thermal process systems described herein may be configured to carefully control deposition of product solids on the substrate material by selectively heating different portions of the retort. A heating assembly may selectively generate different heating zones within the retort, such that a thermal process proceeds only within the corresponding heating zone. Once a portion of the substrate material within a heating zone is loaded, the heating assembly may generate another heating zone to load another portion of the substrate material. This selective heating process may continue until the entire substrate material is loaded, after which the substrate material may be removed. Such a thermal process system may be particularly useful for particle-based substrate materials that can be easily loaded as a fluidized mass or cartridge and removed as a monolithic composite of the particles and the product solids, thereby enabling automation of the thermal process system. In this way, thermal process systems described herein may improve loading of the substrate material and reduce power consumption of the thermal process system.

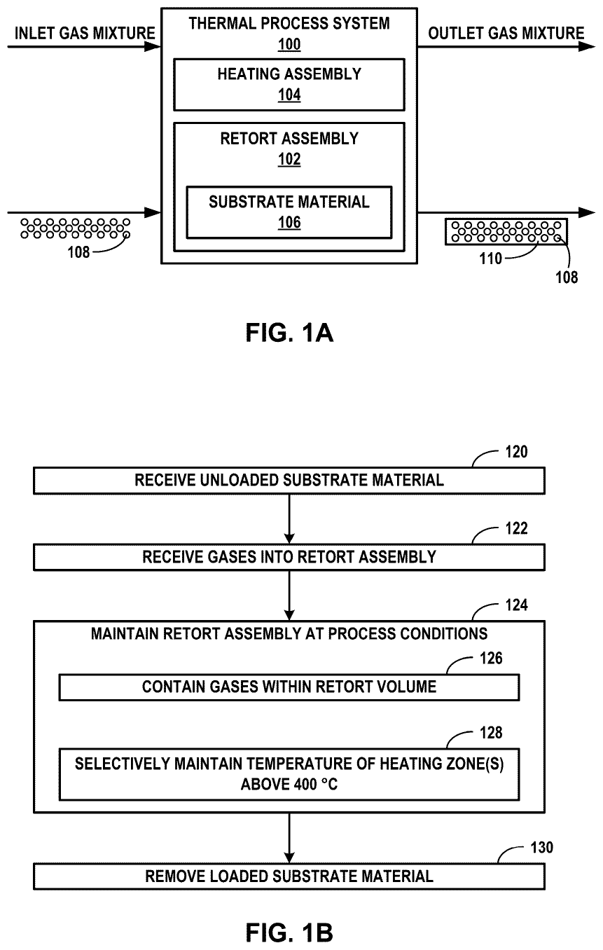

FIG. 1A is a schematic block diagram illustrating an example thermal process system 100. Thermal process system 100 is configured to control a thermal process that generates an outlet gas mixture and a product solid 110 from an inlet gas mixture. For example, outlet gas mixture and product solid 110 may be reaction products of the inlet gas mixture, decomposition products of the inlet gas mixture, or different phases of the inlet gas mixture. Thermal process system 100 includes a retort assembly 102 and a heating assembly 104. Retort assembly 102 is configured to substantially contain one or more gases, such as gases of the inlet and/or outlet gas mixtures, in a retort chamber during the thermal process and house one or more substrate materials 106 within the retort chamber.

Substrate material 106 may include any form of substrate material having a relatively high surface area, including loose particles, partially consolidated particles, and/or fibers. In the example of FIG. 1A, thermal process system 100 includes a particle-based substrate material 106 that includes particles 108. Particles 108 may be configured to have a relatively high surface area, void fraction, and thermal stability, such that particles 108 may receive a high loading of product solids 110 at conditions of the thermal process. A variety of properties of particles 108 may be related to a surface area and void fraction of particles 108, such as a particle size, particle distribution, particle porosity, particle composition, or the like. Prior to deposition, particles 108 may be loose or loosely adhered, such that particles 108 may be packed into thermal process system 100. After deposition of product solids 110, particles 108 may be contained within a binder phase formed by product solids 110. The resulting composite substrate material 106 may be removable from thermal process system 100 once loaded with product solids 110 and replaced with new particles 108.

Heating assembly 104 includes a plurality of heating elements adjacent to the retort chamber of retort assembly 102. Heating assembly 104 is configured to selectively generate two or more heating zones at different axial positions within a heating region. Once generated, each heating zone may cause product solids 110 to selectively deposit on portions of substrate material 106 that are within the respective heating zone. For example, a first portion of substrate material 106 that is more proximal to an inlet of thermal process system 100 may be deposited with product solids 110 until a desired loading, and a second portion of substrate material 106 that is more distal to the first portion may be subsequently deposited with product solids 110 until the desired loading, until all portions of substrate material 106 are deposited with product solids 110 to the desired loading, such as to a desired threshold (e.g., indicated by lowered rate of the thermal process). Such selective deposition of product solids 110 may be controlled by heating the corresponding portions of thermal process system to generate the heating zone, such that only the portion of substrate material 106 within process gases at thermal process conditions may experience deposition of product solids 110. As a result, thermal process system 100 may be loaded by a reduced cumulative power and to a higher overall loading compared to a thermal process system that is heated uniformly.

FIG. 1B is a flowchart of an example technique for selectively depositing product solids in a thermal process system. Reference will be made to thermal process system 100A of FIG. 1A; however, other thermal process systems may be used to perform the technique of FIG. 1B. The method includes receiving an unloaded substrate material 106 into retort assembly 102 (120). In examples in which substrate material 106 includes particles 108, receiving the unloaded substrate material 106 may include loading particles 108 contained within a cartridge into a retort chamber of retort assembly 102.

The method includes receiving gases into the retort chamber of retort assembly 102 (122). The gases may include any combination of process gases, such as reactant gases, inert gases, or other gases used in or produced from the thermal process. The method includes maintaining retort assembly 104 at thermal process conditions (124). To maintain retort assembly 104 at thermal process conditions, retort assembly 104 may contain gases within the retort volume (126), such as by using conventional vacuum seals, as will be described further below. To control the thermal process in different portions of substrate material 106, heating assembly 104 may maintain a temperature of a portion of the retort volume within the retort chamber above a threshold temperature, such as about 400° C., to generate a selected heating zone (128). Such temperatures may be substantially higher than a thermal degradation temperature of the seals used to contain the gases, but may be accommodated due to a position of the seals away from the heating region.

Heating assembly 104 may sequentially heat different portions of the retort volume of retort assembly 102 to selectively deposit product solid 110 on substrate material 106, such that other portions of substrate material 106, such as portions either already loaded or yet to be loaded, may not be heated. For example, for two or more heating zones, selectively and sequentially generating the two or more heating zones may include generating a first heating zone at a first time to deposit a product solid on a first portion of substrate material 106, followed by generating a second heating zone at a second time to deposit the product solid on a second portion of substrate material 106. The first heating zone may be generated by a first set of heating elements at a first axial position, while the second heating zone may be generated by a second set of heating elements at a second axial position. The amount of time during which the heating zones are generated may correspond to a desired loading threshold of the respective portion of substrate material 106. For example, the desired loading threshold may greater than about 95 percent of a maximum loading capacity of substrate material 106.

Once product solid 110 has substantially loaded substrate material 106, substrate material 106 may be removed from retort chamber 208 (130). The resulting loaded substrate material 106 may have a higher loading and/or may consume less power to create a particular loading than thermal process systems that do not selective heat different portions of a retort assembly to spatially control deposition of product solids.

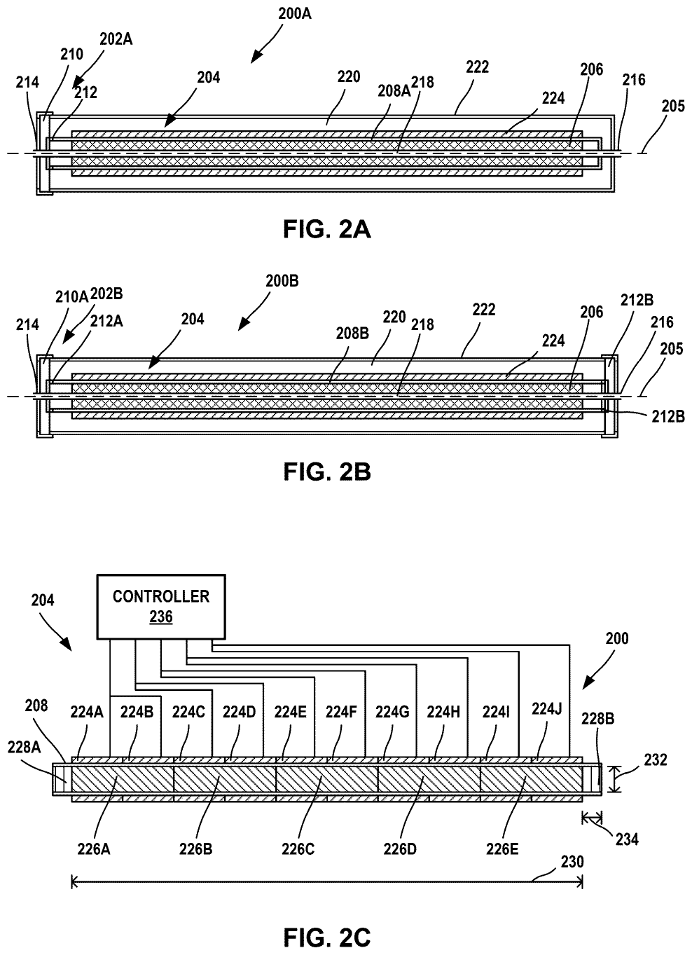

FIGS. 2A and 2B are a cross-sectional side view diagrams illustrating example thermal process systems 200A and 200B for generating an outlet gas mixture and capturing thermal process product on a substrate material 206. Thermal process systems 200A or 200B may represent more detailed diagrams of, for example, thermal process system 100 of FIG. 1A. Collective or generic components may be referred to without a letter suffix and/or without a figure referenced for a specific context.

Each thermal process system 200A and 200B includes a retort assembly 202A and 202B. In the example of FIG. 2A, retort assembly 202A includes a retort chamber 208A with a single opening at a first end and a removable retort lid 210 covering the opening at the first end. In the example of FIG. 2B, retort assembly 202B includes a retort chamber 208B with two openings at first and second ends and a first removable retort lid 210A covering the opening at the first end and a second removable retort lid 210B covering the opening at the second end.

Each retort assembly 202 is configured maintain a containment boundary for the one or more gases in retort chamber 208 during a thermal process, such as a reaction. For example, retort chamber 208 and retort lid(s) 210 may define a thermal process volume in which one or more process gases undergo the thermal process. In the example of FIGS. 2A and 2B, seals 212 are used to form the containment boundary. Each retort lid 210 is configured to contact a wall of retort chamber 208 via a seal 212, such as one or more O-rings. In the example of FIG. 2A, retort lid 210 is configured to secure a seal 212 between retort lid 210 and retort chamber 208. Retort lid 210 is positioned at the first end of retort assembly 202A and includes inlet 214, such that seal 212 may experience gases at a relatively lower temperature than at an outlet 216 of retort assembly 202A. In the example of FIG. 2B, each of retort lids 210A and 210B is configured to seal against the respect end of retort chamber 208B via first seal 212A or second seal 212B. Such configuration may be particularly useful for removing substrate material 206. For example, after the thermal process, substrate material 206 may be substantially solid. To remove loaded substrate material 206, substrate material 206 may be pushed at one end and removed from the opposite end.

While seals 212 are described as being physical seals, seals 212 may include one or more contact seals. For example, retort chamber 208 and retort lid 210 may be sealed against each other using a contact seal formed by surfaces of retort chamber 208 and lid 210. The lack of gasket or other removable sealing materials may enable retort assembly 202, including the contact seal, to be positioned within one or more layers of insulation at a relatively high temperature, thereby reducing an amount of power to maintain the temperature within retort assembly 202, without negatively affecting containment (e.g., which may be further provided by vessel housing 222). Such contact seal may be particularly suitable for thermal processes for which flow into or out of retort assembly 202 may be subject to relatively low mass transfer rates driven primarily by concentration gradients of the gases within retort assembly 202 and other gases outside retort assembly 202 (causing diffusive flow), rather than an absolute pressure differential (causing bulk flow), such that retort assembly 202 may be sealed without the use of additional, low temperature capable sealing structures, and hermiticity is not a requirement.

Once positioned, retort chamber 208 and retort lid 210 may be configured to contain the one or more gases and substantially prevent process gases from migrating into the retort volume of retort chamber 208. Thermal process system 200 may include a clamp or other mechanical assembly configured to directly or indirectly exert relative force between retort chamber 208 and retort lid 210, such as to maintain compression of retort lid 210 on seal 212 and inhibit gas migration across seal 212. Such compression may maintain a hermetic seal. In some examples, the mechanical assembly may be capable of being removed robotically. For example, the mechanical assembly may be substantially large, such that a robotic tool may be capable of operating the mechanical assembly and removing retort lid 210 to access substrate material 206. Seal 212 may be formed from materials that have a relatively high degradation temperature that still may be lower than a temperature of the thermal process. For example, seal 212 may have a thermal degradation temperature that is less than about 350° C., and/or may be formed from polymers or other materials that may resist high temperatures, but not very high temperatures such as those experienced during methane pyrolysis. Materials used for seals 212 may include, but are not limited to, materials that do not degrade up to about 400° C., such as fluorocarbon elastomers (FKM), perfluoro elastomers (FFKM), graphite, polytetrafluoroethylene (PTFE), silicone rubber, or viton; and/or materials that do not degrade up to about 850° C., such as ceramic fibers, refractory ceramic composites, graphite, or mica-based materials. For example, both fluorocarbon elastomers and perfluoro elastomers may have high chemical resistance, such as to oils, fuels, solvents, acids, and bases; high temperature stability, such as up to 250° C. (for FKM) or 330° C. (for FFKM), good mechanical properties, such as good compression set resistance; low gas permeability; and high resistance to ageing and environmental factors such as UV light and oxidation. As will be described further below, seal 212 may be located in a portion of retort assembly 202A that may have a lower temperature than other portions of retort assembly 202A, such as portions near heating assembly 204.

Retort chamber 208 may have a variety of generally tubular shapes. While each retort chambers 208A and 208B may be illustrated as having a generally linear shape, in other examples, retort chamber 208 may have a curved shape having a relatively uniform curvature. Each retort assembly 202 is configured for general flow along longitudinal axis 205 of retort chamber 208, such that process gases, such as hydrocarbon gases, may be continuously received and product gases, such as hydrogen gas, reaction byproducts, and unreacted hydrocarbon gases, may be continuously discharged from thermal process system 200. As will be described below, such “general flow” may still include axial flow from a flow path interior to substrate material 206 to a flow path exterior to substrate material 206, or vice versa. Retort chamber 208 may be sized to have a particular residence time and pressure drop for a particular flow rate of gases and particular void fraction of substrate material 206.

During a thermal process, such as a reaction or deposition process, portions of the retort volume within retort chamber 208 may be at relatively high temperatures. For example, a particular portion of the retort volume may have a temperature greater than about 850° C., such as for methane pyrolysis operations. As such, retort chamber 208 and retort lid 210 may be configured for exposure to relatively high temperatures. In some examples, each of retort lid 210 and retort chamber 208 includes non-metallic materials, such as graphite, a ceramic, or a ceramic matrix composite. Non-metallic materials may be stronger and more resistant to creep, corrosion, instabilities, or other high temperature structural defects than metals, and can also be designed with non-isotropic thermal conductivity, preferentially passing heat radially into the reaction zone compared to axially, smearing the effects of zonal heating. In some examples, a surface of retort chamber 208 and retort lid 210 may include a ceramic coating, such as a silicon carbide coating or other coating compatible with particular gases contained within retort chamber 208. Properties of interest for materials of retort chamber 208 and retort lid 210 may include, but are not limited to: reduced density, such as to reduce weight; increased chemical compatibility with gases, such as methane and hydrogen, at high temperatures; thermal stability; thermal conductivity; hardness, such as to increase robustness and/or dimensional stability; manufacturability; and the like.

In some examples, a material of retort chamber 208 and retort lid 210 may include graphite. Graphite has excellent high-temperature capabilities, including stability up to 2700° C., has excellent thermal shock properties, has low density, is chemically inert in a methane/hydrogen environment, and is easily machinable. While graphite has a lower strength than other advanced ceramics, retort chamber 208 and retort lid 210 may be subject to relatively low mechanical loads. To improve the hardness of the graphite, an in-situ reaction layer of SiC can be applied, which may improve the robustness of portions of retort assembly 102A that may be frequently accessed. In some examples, a material of retort chamber 208 and retort lid 210 may include a ceramic such as silicon carbide (SiC) or silicon nitride (Si₃N₄), or a ceramic matrix composite, such as SiC/SiC or carbon/carbon composite.

Each retort assembly 202 includes one or more inlets 214 at a first end of retort assembly 202 and one or more outlets 216 at a second end of retort assembly 202. Inlet 214 is configured to discharge an inlet gas mixture into retort chamber 208, and outlet 216 is configured to discharge an outlet gas mixture from retort chamber 208. Inlet 214 and outlet 216 define a general flow of inlet and outlet gas mixtures through retort chamber 208, such that gases may flow from inlet 214 through the retort volume within retort chamber 208, including substrate material 206, and to outlet 216. In some examples, retort assembly 202 further includes one or more porous pipes 218 extending along longitudinal axis 205 of retort chamber 208. Each pipe 218 is configured to discharge the inlet gas mixture into substrate material 206 and/or permit bypass of the inlet gas mixture through substrate material 206.

Retort chamber 208 is configured to house substrate material 206 within retort chamber 208. In the example of FIG. 2A, the first end of retort chamber 208A is configured to permit passage of substrate material 206 into and out of retort chamber 208A, while in the example of FIG. 2B, both the first and second ends of retort chamber 208B may be configured to permit passage of substrate material 206 into and out of retort chamber 208B. For example, prior to loading, substrate material 206 may be in a particulate form that includes dispersed particles packed together in retort chamber 208, either free or in a cartridge. After deposition of a product solid, the product solid may bind particles together, such that substrate material 206 may be substantially monolithic. As a result, at least one end of retort chamber 208 may include an opening that is sized to permit removal of substrate material 206.

Retort chamber 208 may house substrate material 206 in a spatial arrangement that channels process gases through and/or around substrate material 206. In some examples, retort chamber 208 includes a frame configured to position one or more substrate material 206 in retort chamber 208. For example, substrate material 206 may be positioned in retort chamber 208 with a gap between an outer boundary of substrate material 206 and an inner surface of retort chamber 208, such that process gases may bypass and flow around substrate material 206 with a small pressure drop and/or may access different portions of substrate material 206 without travelling through open pores of substrate material 206 that may become filled as product solids deposit on substrate material 206. A frame may include one or more structures between and/or around substrate material 206 that are configured to position substrate 206 in the spatial arrangement, and/or accommodate cartridges that hold substrate material 206, such as loose particles. In some examples, the frame may be configured to bypass at least a portion of the flow of the gas mixtures around or through substrate material 206.

Prior to loading, each substrate material 206 may include a plurality of particles. Particles may be configured to operate under thermal process conditions, and may have a relatively high melting or thermal degradation temperature, so as to maintain structural stability throughout the entire range of possible thermal process temperatures. In some examples, the plurality of particles may be configured and arranged to remove carbon with reduced soot formation. For example, to increase deposition of carbon and reduce formation of soot, substrate material 206 may be configured to provide a sufficiently high surface area for a particular volume of gas, such that intermediates of pyrolyzed hydrocarbons favor surface reactions on the particles or fibers of substrate material 206.

In some examples, thermal process system 200 includes thermal retention materials surrounding retort chamber 208 and/or retort lid 210 configured to retain heat within retort chamber 208. Each thermal process system 200 may include insulation 220 surrounding retort chamber 208 and heating elements 224. Insulation 220 is configured to reduce thermal conductive and radiative losses from retort chamber 208. Insulation 220 includes solid insulation material, such as a solid microporous ceramic insulation material capable of working temperatures up to about 1200° C. In addition to providing insulative properties, solid insulation material may be used as a structural support for retort chamber 208 and retort lid 210 by securely positioning retort chamber 208 and retort lid 210 within vessel housing 222. In some examples, as an alternative or in addition to insulation materials, thermal process system 200 may include heat shields configured to reduce thermal radiative losses from retort chamber 208. For example, one or more metallic heat shields may be positioned around at least a portion of retort chamber 208 and/or retort lid 210 to reflect radiation back to retort chamber 208 and/or retort lid 210, such as on an inner surface of insulation 220.

Each thermal process system 200 may include vessel housing 222 positioned around retort chamber 208 and the plurality of heating elements. Vessel housing 222 is configured to maintain a boundary for one or more gases in retort chamber 208. Materials used for vessel housing 222 may be selected for relatively low weight, such as aluminum. In some examples, vessel housing 222 may be configured in two or more sections to at least partially disassemble to access substrate material 206 within retort chamber 208.

Thermal process system 200 includes a heating assembly 204. Heating assembly 204 includes a plurality of heating elements 224 adjacent to and positioned around retort chamber 208. A variety of heating mechanisms may be used for heating elements 224 including, but not limited to: external or internal resistive heating elements, such as ceramic resistive heater rods; induction heating elements, contact heating elements for resistively heating substrate material 206, and the like. In some examples, heating elements 224 include resistive heating rods connected in series, such as by arc-shaped ceramic bus bars. These heating rods can be made from a wide variety of materials, including graphite, a ceramic, such as silicon carbide (SiC), a ceramic matrix composite, such as SiC/SiC composites, metals, such as molybdenum, tungsten, or kanthal, molybdenum silicate (MoSi₂), and the like. Electrical connections for heating assembly 204 may be positioned opposite retort lid 210 or through other interfaces that may not interfere with removal of retort lid 210 from retort chamber 208.

Heating assembly 204 is configured to selectively heat portions of retort chamber 208 and, corresponding, portions of substrate material 206. The plurality of heating elements 224 is configured to selectively generate two or more heating zones at different axial positions along longitudinal axis 205 within a heating region, such as through modular arrangement or control of different heating elements 224 or groups of heating elements 224. As will be discussed in FIG. 2C below, fewer than all of the plurality of heating elements 224 may be activated, such that heating of substrate material 206 may be sequential using at least two heating stages and spatial using at least two different axial heating zones.

FIG. 2C is a cross-sectional side view diagram illustrating generation of a heating region by an example thermal process system 200, such as thermal process systems 200A or 200B of FIGS. 2A and 2B. In the example of FIG. 2C, heating assembly 204 includes ten heating elements 224A, 224B, 224C, 224D, 224E, 224F, 224G, 224H, 224I, 224J; however, any plurality of heating elements 224 may be used. Heating assembly 204 is configured to selectively generate two or more heating zones 226. In the example of FIG. 2C, a pair of adjacent heating elements 224 generate five heating zones 226A, 226B, 226C, 226D, 226E that form a heating region. Each heating zone 226 may correspond to an axial range along heating assembly 204.

A controller 136 may be configured to selectively control plurality of heating elements 224 to generate a single heating zone 226 of the two or more heating zones 226. To selectively generate a heating zone 226, such as heating zone 226A, heating elements 224A and 224B may be selectively powered while the remaining heating elements 224 of heating assembly 204 remain unpowered.

Due to the selective generation of heating zones 226, the heating region of heating assembly 204 may be relatively one-dimensional, such that a length 230 of the heating region is substantially larger than a width 232 of the retort chamber. In some examples, a ratio of length 230 of the heating region to width 232 of the retort chamber is greater than or equal to about 10. Retort chamber 208 may extend beyond the heating region on one or more ends, such as ends that include a retort lid 210, to form end regions 228A and/or 228B. A length 234 of end regions 228A and 228B may be selected to create a temperature gradient between a relatively high temperature of the heating region and a relatively low temperature of a portion of heating retort chamber 208 near one or more seals 212, as shown in FIGS. 2A and 2B. For example, length 234 may be selected such that seals 212 may be exposed to a temperature of less than about 800° C.

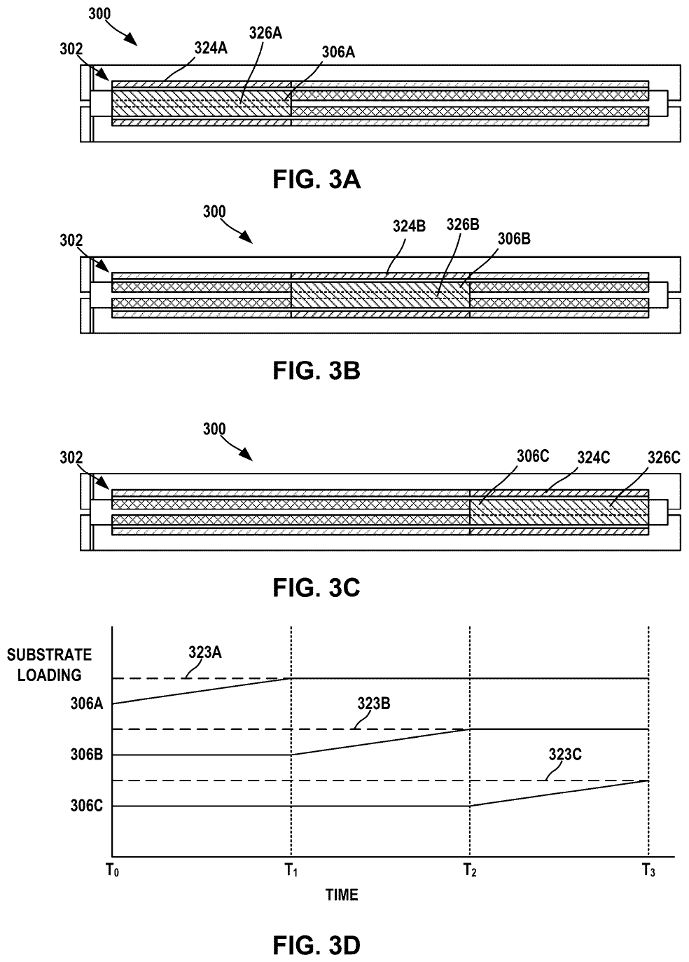

Thermal process systems described herein may be configured to sequentially generate different heating zones, such as heating zones 226 of FIG. 2C, to cause different portions of a substrate material to receive product solids. FIGS. 3A-3D illustrate example sequential deposition of a product solid onto a substrate material in three different phases. FIGS. 3A, 3B, and 3C are cross-sectional side view diagrams illustrating generation of a first heating zone 326A at a first axial position, a second heating zone 326B at a second axial position, and a third heating zone 326C at a third axial position, respectively, by an example thermal process system 300, such as thermal process systems 200A or 200B of FIGS. 2A or 2B. FIG. 3D is a graph illustrating temperature of the thermal process system for the first, second, and third heating zones 326A-C of FIGS. 3A-3C.

As illustrated in FIG. 3A, a first heating element 324A generate first heating zone 326A to raise a portion of thermal process system 300 above a threshold temperature for undergoing a thermal process. Due to the thermal process, product solids may form on a first portion 306A of a substrate material 300, as illustrated starting at To in FIG. 3D. While shown as a linear increase, product solids may form at varying rates, such as a slowed rate as loading increases and a surface area of first portion 306A decreases. Other portions of thermal process system 300 may remain below the threshold temperature, such that product solids do not substantially form on portions of substrate material 306, such as portions 306B and 306C, that are not within the portion of thermal process system 300 above the threshold temperature. For example, other portions of substrate material 306 may remain at least about 100° C. below the threshold temperature. Thermal process system 300 may continue to generate heating zone 326A until a threshold loading 323A for first portion 306A is reached at T₁, after which first heating element 324A may stop generating heating zone 326A.

As illustrated in FIG. 3B, a second heating element 324B may generate second heating zone 326B to raise a portion of thermal process system 300 above the threshold temperature for undergoing the thermal process, and product solids may form on a second portion 306C of substrate material 306, as illustrated starting at T₁ in FIG. 3D. Thermal process system 300 may continue to generate second heating zone 326B until a threshold loading 323B for second portion 306B is reached at T₂, after which second heating element 324B may stop generating second heating zone 326B. As illustrated in FIG. 2C, a third heating element 324C may generate third heating zone 326C to raise a portion of thermal process system 200 above the threshold temperature for undergoing the thermal process, and product solids may form on a third portion 306C of substrate material 306, as illustrated starting at T₂ in FIG. 3D. Thermal process system 300 may continue to generate third heating zone 326C until a threshold loading 323C for third portion 306C is reached at T₃, after which third heating element 324C may stop generating third heating zone 326C.

During generation of each of first, second, and third heating zones 226A-C, only a single heating zone 326 may be generated. As a result, the thermal process, and correspondingly the deposition of the product solids, can be carefully controlled so as to improve overall loading of substrate material 306. For example, if a thermal process system raises an entire retort volume above the threshold temperature for the thermal process, the product solids will form on different portions of substrate material 306 at different rates. Such deposition rates may be dependent on a variety of factors, such as a local temperature of substrate material 306, a concentration of the process gases, and a residence time of the process gases. As one example, a temperature of substrate material 306 may vary based on a proximity of substrate material 306 to a heating element, which may increase radially, and a temperature of the process gases contacting substrate material 306, which may increase axially. As a result, portions of substrate material 306 near an outer surface and an outlet of the retort volume may have higher deposition rates than portions of substrate material 306 near an interior and an inlet of the retort volume. As another example, a concentration of the process gases may vary based on an extent of the thermal process, which may increase axially. As a result, portions of substrate material 306 near an inlet of the retort volume may have higher deposition rates than portions of substrate material 306 near an outlet of the retort volume. By controlling deposition, such spatial variation of deposition rates may be more carefully controlled to improve loading for a particular amount of power consumed.

While FIGS. 3A-3D have been described with respect to sequential deposition of product solids from a first end near an inlet to a second end near an outlet of retort assembly 302, in some examples, other sequences may be used. In some examples, heating zones 326 may be generated in a different order, or may be generated multiple times. For example, due to the thermal leakage at the ends or substrate material settling, retort assembly 302 may be heated more than once. In some examples, heating zones 326 may be generated simultaneously. For example, heating zones 326 may have uniform generation for a first period of time, followed by sequential generation once a base loading is reached. In some examples, heating zones 326 may be generated at different power levels. For example, heating zones 326 may be generated at lower power for areas that tend to have higher deposition rates or higher power for areas that tend to have thermal leakage, followed by sequential generation once a base loading of at least one portion of substrate material 306 is reached.

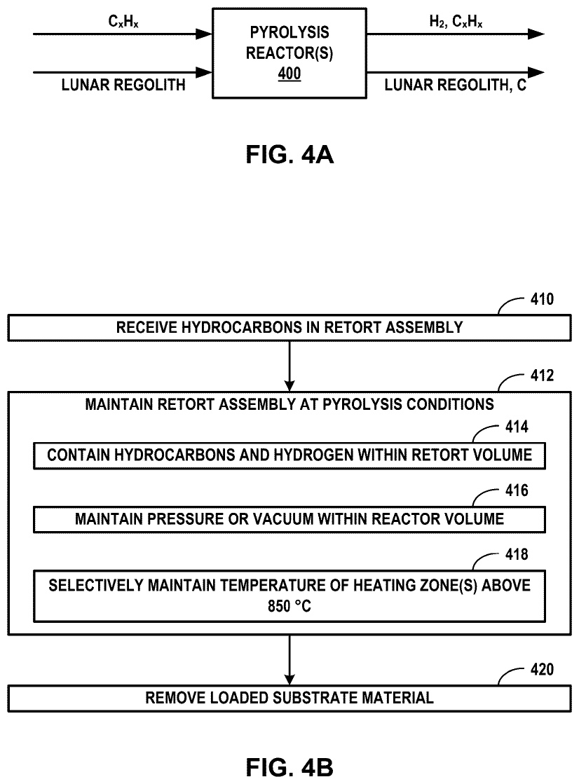

In some examples, thermal process systems described herein may be used for generating useful gases, such as hydrogen gas, while capturing product solids on substrate materials readily available in an outer space environment. FIG. 4A is a schematic block diagram illustrating an example pyrolysis reactor 400 for generating hydrogen gas and capturing carbon on a lunar regolith substrate material. Pyrolysis reactor 400 may be configured to generate hydrogen gas from hydrocarbons through pyrolysis. In the example of FIG. 4A, pyrolysis reactor 400 may be configured to generate hydrogen gas and carbon from methane, such as according to the following endothermic reaction:

CH₄(g)→2H₂(g)+C(s)

Pyrolysis reactor 400 may include lunar regolith particles as a substrate material. Lunar regolith is a layer of loose, heterogeneous material covering solid rock on a surface of the moon. Lunar regolith is composed of a mixture of fine dust, small rock fragments, and larger rocks. A composition of lunar regolith particles may include minerals, such as silicates (e.g., plagioclase feldspar, pyroxenes, olivine, ilmenite), glasses (e.g., formed from impact that melts the surface material which subsequently cools), agglutinates (e.g., formed from impacts that weld particles together), volatiles (e.g., hydrogen, helium, carbon, nitrogen, or other gases implanted), and/or iron (e.g., reduced from oxides). Lunar regolith, in its raw form, may have particles sized from about 1 micrometer up to large rocks, the latter of which may be further processed to reduce a size and increase a surface area of the lunar regolith. Lunar regolith may be processed, for example, by at least one of crushing, grinding, or sieving, to form a powder or dust.

Lunar regolith particles may be configured to provide a deposition surface for carbon generated from the pyrolysis of the hydrocarbons. Prior to deposition, the substrate material may be present as a collection of lunar regolith particles. As pyrolysis progresses, an increasing amount of carbon may be generated, such that the lunar regolith particles progressively include an increasing fraction of coated substrate particles. Eventually, substantially an entirety of the particles may include coated particles with continued carbon deposition. After deposition of carbon, the substrate material may be a composite of lunar regolith particles contained within a carbon matrix formed by the deposited carbon. This substrate material may be removable from pyrolysis reactors 106 once spent and replaced with new substrate material. In some examples, the carbon-coated particles may be further heated, such as in pyrolysis reactor 400 or in a separate carbothermal reactor, to produce one or both of carbon monoxide or carbon dioxide.

As explained above, pyrolysis reactor 400 may be configured to selectively deposit carbon on portions of the lunar regolith particles, such that pyrolysis reactors 400 may operate with lower power. For example, a first portion of the lunar regolith particles that is more proximal to an inlet of pyrolysis reactor 400 may be deposited with carbon until a desired loading, and a second portion of the lunar regolith particles that is more distal to the first portion may be deposited with carbon until the desired loading, until the substrate material is deposited with carbon to the desired loading, such as greater than about 95% of a maximum loading. Such selective deposition of carbon may be controlled by heating the corresponding portions of pyrolysis reactor 400, such that only the portion of the lunar regolith particles that are within process gases at pyrolysis conditions may experience deposition of the carbon. As a result, pyrolysis reactor 400 may be loaded by a reduced cumulative power and to a higher overall loading compared to a pyrolysis reactor that is heated uniformly.

FIG. 4B is a flowchart of an example technique for pyrolyzing hydrocarbons in a pyrolysis reactor. Reference will be made to thermal process systems 200A and 200B of FIGS. 2A and 2B; however, other thermal process systems may be used to perform the technique of FIG. 4B. The method includes receiving gases into retort chamber 208 (410). The method includes maintaining a retort volume within retort chamber 208 at pyrolysis conditions (412), such that methane is consumed to form hydrogen gas and carbon. Retort chamber 208 and retort lid 210 may seal against each other via seal 212 to contain gases within the retort volume (414). The controller may control a vacuum of methane and/or hydrogen gas streams received by inlet 214 and/or discharged by outlet 216. Retort assembly 202 may maintain the pressure or vacuum within the reactor volume (416). To control pyrolysis in different portions of substrate material 206, the controller may operate heating elements 224 to maintain a temperature of portions of the retort volume within retort chamber 208 above a threshold temperature, such as about 850° C., to generate a selected heating zone 226 (418). Once the carbon has substantially loaded substrate material 206, substrate material 206 may be removed from retort chamber 208 (420).

Example 1: A thermal process system includes a retort assembly includes substantially contain one or more gases in the retort chamber during a thermal process; and house substrate material within the retort chamber; and a heating assembly comprising a plurality of heating elements adjacent to the retort chamber, wherein the plurality of heating elements is configured to selectively generate two or more heating zones at different axial positions along the longitudinal axis within a heating region.

Example 2: The thermal process system of example 1, wherein, to selectively generate the two or more heating zones, the plurality of heating elements is configured to: generate, by a first set of heating elements of the plurality of heating elements at a first axial position, a first heating zone; and generate, by a second set of heating elements of the plurality of heating elements at a second axial position, a second heating zone.

Example 3: The thermal process system of any of examples 1 and 2, wherein a ratio of a length of the heating region to a width of the retort chamber is greater than or equal to about 10.

Example 4: The thermal process system of any of examples 1 through 3,wherein the retort assembly comprises: an inlet at a first end configured to discharge an inlet gas mixture into the retort chamber; and an outlet at a second end configured to receive an outlet gas mixture from the retort chamber, wherein the inlet and the outlet are configured to define flow of the gas mixtures through the retort chamber, and wherein the retort assembly is configured to bypass at least a portion of the flow of the gas mixtures around or through the substrate material.

Example 5: The thermal process system of example 4, wherein the retort assembly further comprises one or more porous pipes extending along the longitudinal axis and configured to discharge the inlet gas mixture into the substrate material.

Example 6: The thermal process system of any of examples 4 and 5, wherein the retort assembly comprises a retort lid positioned at at least one of the first end or the second end and configured to secure against the retort chamber of the retort assembly, and wherein the respective first end or second end is configured to permit passage of the substrate material in a consolidated form.

Example 7: The thermal process system of example 6, wherein the retort lid is configured to secure a seal between the retort lid and the retort chamber.

Example 8: The thermal process system of any of examples 1 through 7, further includes a vessel housing positioned around the retort chamber and the plurality of heating elements; and insulation material between positioned between the retort chamber and the vessel housing.

Example 9: The thermal process system of any of examples 1 through 8, further comprising a frame configured to position the substrate material in the retort chamber.

Example 10: The thermal process system of any of examples 1 through 9, further comprising a computing device configured to selectively control the plurality of heating elements to generate a single heating zone of the two or more heating zones.

Example 11: The thermal process system of any of examples 1 through 10, wherein the thermal process system is a pyrolysis reactor configured to generate hydrogen gas from a hydrocarbon through pyrolysis.

Example 12: The thermal process system of any of examples 1 through 11, wherein the substrate material comprises lunar regolith particles.

Example 13: A method includes containing, by a retort assembly of a thermal process system, one or more gases in a retort chamber of the retort assembly during a thermal process, wherein the retort assembly comprising a retort chamber defining a longitudinal axis, and wherein the retort assembly houses substrate material within the retort chamber; and maintaining, by a heating assembly of the thermal process system, the one or more gases at thermal process conditions by selectively generating, by a plurality of heating elements of the heating assembly, two or more heating zones at different axial positions along the longitudinal axis within a heating region, wherein the plurality of heating elements is adjacent to the retort chamber.

Example 14: The method of example 13, wherein selectively generating the two or more heating zones comprises at least: generating, by a first set of heating elements of the plurality of heating elements at a first axial position, a first heating zone at a first time to deposit a product solid on a first portion of the substrate material; and generating, by a second set of heating elements of the plurality of heating elements at a second axial position, a second heating zone at a second time to deposit the product solid on a second portion of the substrate material.

Example 15: The method of example 14, wherein the first time and the second time correspond to a desired loading threshold of the respective first portion and second portion of the substrate material.

Example 16: The method of example 15, wherein the desired loading threshold is greater than about 95 percent of a maximum loading capacity of the substrate material.

Example 17: The method of any of examples 13 through 16, further includes receiving, by an inlet at a first end of the retort assembly, an inlet gas mixture into the retort chamber; and discharging, by an outlet at a second end of the retort assembly, an outlet gas mixture from the retort chamber, and wherein the inlet and the outlet are configured to define flow of the inlet and outlet gas mixtures through the retort chamber.

Example 18: The method of any of examples 13 through 17, wherein

maintaining a temperature of the one or more gases in a retort volume within the retort chamber above about 400° C.

Example 19: The method of any of examples 13 through 18, wherein the thermal process system is a pyrolysis reactor configured to generate hydrogen gas from a hydrocarbon through pyrolysis.

Example 20: The method of any of examples 13 through 19, wherein the substrate material comprises lunar regolith particles.

Various examples have been described. These and other examples are within the scope of the following claims.

What is claimed is:

1. A thermal process system, comprising:
a retort assembly comprising a retort chamber defining a longitudinal axis, wherein the retort assembly is configured to:
substantially contain one or more gases in the retort chamber during a thermal process; and
house substrate material within the retort chamber; and
a heating assembly comprising a plurality of heating elements adjacent to the retort chamber, wherein the plurality of heating elements is configured to selectively generate two or more heating zones at different axial positions along the longitudinal axis within a heating region.

2. The thermal process system of claim 1, wherein, to selectively generate the two or more heating zones, the plurality of heating elements is configured to:
generate, by a first set of heating elements of the plurality of heating elements at a first axial position, a first heating zone; and
generate, by a second set of heating elements of the plurality of heating elements at a second axial position, a second heating zone.

3. The thermal process system of claim 1, wherein a ratio of a length of the heating region to a width of the retort chamber is greater than or equal to about 10.

4. The thermal process system of claim 1,
wherein the retort assembly comprises:
an inlet at a first end configured to discharge an inlet gas mixture into the retort chamber; and
an outlet at a second end configured to receive an outlet gas mixture from the retort chamber,
wherein the inlet and the outlet are configured to define flow of the gas mixtures through the retort chamber, and
wherein the retort assembly is configured to bypass at least a portion of the flow of the gas mixtures around or through the substrate material.

5. The thermal process system of claim 4, wherein the retort assembly further comprises one or more porous pipes extending along the longitudinal axis and configured to discharge the inlet gas mixture into the substrate material.

6. The thermal process system of claim 4,
wherein the retort assembly comprises a retort lid positioned at at least one of the first end or the second end and configured to secure against the retort chamber of the retort assembly, and
wherein the respective first end or second end is configured to permit passage of the substrate material in a consolidated form.

7. The thermal process system of claim 6, wherein the retort lid is configured to secure a seal between the retort lid and the retort chamber.

8. The thermal process system of claim 1, further comprising:
a vessel housing positioned around the retort chamber and the plurality of heating elements; and
insulation material between positioned between the retort chamber and the vessel housing.

9. The thermal process system of claim 1, further comprising a frame configured to position the substrate material in the retort chamber.

10. The thermal process system of claim 1, further comprising a computing device configured to selectively control the plurality of heating elements to generate a single heating zone of the two or more heating zones.

11. The thermal process system of claim 1, wherein the thermal process system is a pyrolysis reactor configured to generate hydrogen gas from a hydrocarbon through pyrolysis.

12. The thermal process system of claim 1, wherein the substrate material comprises lunar regolith particles.

13. A method, comprising:
containing, by a retort assembly of a thermal process system, one or more gases in a retort chamber of the retort assembly during a thermal process, wherein the retort assembly comprising a retort chamber defining a longitudinal axis, and wherein the retort assembly houses substrate material within the retort chamber; and
maintaining, by a heating assembly of the thermal process system, the one or more gases at thermal process conditions by selectively generating, by a plurality of heating elements of the heating assembly, two or more heating zones at different axial positions along the longitudinal axis within a heating region, wherein the plurality of heating elements is adjacent to the retort chamber.

14. The method of claim 13, wherein selectively generating the two or more heating zones comprises at least:
generating, by a first set of heating elements of the plurality of heating elements at a first axial position, a first heating zone at a first time to deposit a product solid on a first portion of the substrate material; and
generating, by a second set of heating elements of the plurality of heating elements at a second axial position, a second heating zone at a second time to deposit the product solid on a second portion of the substrate material.

15. The method of claim 14, wherein the first time and the second time correspond to a desired loading threshold of the respective first portion and second portion of the substrate material.

16. The method of claim 15, wherein the desired loading threshold is greater than about 95 percent of a maximum loading capacity of the substrate material.

17. The method of claim 13, further comprising:
receiving, by an inlet at a first end of the retort assembly, an inlet gas mixture into the retort chamber; and
discharging, by an outlet at a second end of the retort assembly, an outlet gas mixture from the retort chamber, and
wherein the inlet and the outlet are configured to define flow of the inlet and outlet gas mixtures through the retort chamber.

18. The method of claim 13, wherein maintaining a temperature of the one or more gases in a retort volume within the retort chamber above about 400° C.

19. The method of claim 13, wherein the thermal process system is a pyrolysis reactor configured to generate hydrogen gas from a hydrocarbon through pyrolysis.

20. The method of claim 13, wherein the substrate material comprises lunar regolith particles.
